(19) United States
(12) Patent Application Publication
(10) Pub. No.: US 2025/0237759 A1
(43) Pub. Date: Jul. 24, 2025

(54) Method For Sensing Surroundings Of A Vehicle By Means Of A Sensor System On The Basis Of Consecutive Interconnection Of Subarrays Of The Sensor System, And Sensor System And Vehicle

(71) Applicant: Volkswagen Aktiengesellschaft, Wolfsburg (DE)

(72) Inventors: Marc-Michael Meinecke, Sassenburg (DE); Thomas Gisder, Wolfsburg (DE); Heiko Gustav Kurz, Hannover (DE)

(73) Assignee: Volkswagen Aktiengesellschaft, Wolfsburg (DE)

(21) Appl. No.: 19/033,652

(22) Filed: Jan. 22, 2025

(30) Foreign Application Priority Data
Jan. 22, 2024 (DE) 10 2024 200 529.0

(51) Int. Cl. G01S 13/931

(52) U.S. Cl. CPC G01S 13/931; G01S 2013/93271; G01S 2013/93272; G01S 2013/93274

(57) ABSTRACT

The disclosure relates to a method for sensing surroundings by means of a sensor system, comprising: sensing a surroundings region of the surroundings by means of a first subarray, wherein the first subarray comprises a first field of view, sensing the surroundings region by means of a second subarray, wherein the second subarray comprises a second field of view, determining an overlapping region of the fields of view on the basis of overlapping edge regions, checking the overlapping region with regard to whether an object is located therein, and if so: determining a combination array that is composed of antenna elements of the first and second subarray wherein the combination array comprises a combination field of view, wherein the one object can be detected by means of the combination field of view, and sensing the surroundings region of the surroundings by means of the combination array.

### CROSS-REFERENCE TO RELATED APPLICATIONS

This application claims priority to German Patent Application DE 10 2024 200 529.0 filed on Jan. 22, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for sensing surroundings of a vehicle by means of a sensor system, wherein the sensor system comprises an antenna array, wherein antenna elements of the antenna array are arranged so as to be distributed on the vehicle.

Furthermore, the disclosure relates to a sensor system having an antenna array that comprises multiple antenna elements and having a computing apparatus.

The disclosure also relates to a vehicle having a sensor system.

### SUMMARY

A need exists to provide an improved environment sensing of a vehicle using an antenna array of the sensor system that can be adaptively adjusted for environment sensing depending on a present situation.

The need is addressed by the subject matter of the independent claim(s). Embodiments of the invention are described in the dependent claims, the following description, and the drawings.

### BRIEF DESCRIPTION OF THE DRAWINGS

FIG. 1 is a schematic representation of a vehicle having an example sensor system that comprises antenna elements of an antenna array that are arranged so as to be distributed on the vehicle;

FIG. 2 is a schematic representation of a block diagram of the example sensor system from FIG. 1;

FIG. 3 is a schematic representation of a further embodiment of an example radar system from FIG. 1;

FIG. 4 is a schematic example representation of a turn-off driving maneuver in an intersection situation, in which fields of view of subarrays of the example antenna array from FIG. 1 are superimposed one on the other in regions;

FIG. 5 shows, proceeding from FIG. 4, an example combination field of view formed from a combination of the fields of view from FIG. 4 in order to be able to better detect objects in the overlapping region of the fields of view from FIG. 4;

FIG. 6 shows an example flow diagram regarding the sensing of the surroundings region which is relevant to a driving maneuver of the vehicle currently to be carried out;

FIG. 7 shows, proceeding from FIG. 5, how the example combination array in FIG. can be used for further arrays of the antenna array; and

FIG. 8 shows a rotating further adaptation of the example combination array from FIG. 7 to further arrays of the antenna array.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments provide a method for sensing surroundings of a vehicle by means of a sensor system, wherein the sensor system comprises an antenna array, wherein antenna elements of the antenna array are arranged so as to be distributed on the vehicle, said method comprising:
in particular sensing a surroundings region of the surroundings by means of a first subarray of the antenna array, wherein the first subarray comprises a first field of view that extends at least partially within the surroundings region,
in particular sensing the surroundings region of the surroundings by means of at least one second subarray of the antenna array, wherein the second subarray comprises a second field of view that extends at least partially within the surroundings region,
in particular determining an overlapping region of the first and second field of view on the basis of at least partially overlapping edge regions of the first and second field of view,
checking the overlapping region with regard to whether an object to be detected is located within the overlapping region, and if so:
determining a combination array that is composed of antenna elements of the first and second subarray, on the basis of the overlapping region and the at least one object to be detected, wherein the combination array comprises a combination field of view that is composed of parts of the first and second field of view, wherein the at least one object to be detected can be detected by means of the combination field of view, and
sensing the surroundings region of the surroundings by means of the combination array.

By means of the proposed method, the sensing of the environment, surroundings, or a surroundings region of a vehicle can be carried out more efficiently, since the antenna array can be adjusted in a situation-dependent manner depending on the current situation with regard to the environment sensing. Above all, the target detection accuracy and, in particular, the resolution of an antenna array of a sensor system, in particular a radar system, can deteriorate in the respective edge regions of the field of view (FoV). Inaccurate sensing may therefore take place if environment sensing is then to be carried out with an antenna array and objects still to be detected are located in the edge regions or else at the outer side regions of the field of view of the antenna array. This can lead to critical situations, in particular if the detection results of the environment sensing are required for autonomous driving systems or other safety systems.

The antenna array may for example comprise multiple antenna elements, for example transmission elements and receiving elements. These may be arranged so as to be distributed on the vehicle, such that some of these antenna elements may be used to form respective subarrays. For example, a subarray may be arranged on the front region, a further subarray may be arranged on the passenger door, a further subarray may be arranged on the driver's side, and/or a subarray may be arranged on the rear region. Further possible arrangements of the subarrays are also conceivable on the outside of the vehicle in some embodiments.

For example, the surroundings region of the surroundings can be sensed depending on the driving situation or else circumstances. Here, a “surroundings region” may be a region in the surroundings which is relevant to the vehicle. For example, the surroundings region may be a region of the surroundings which is relevant for carrying out a current and/or future driving maneuver of the vehicle. If the vehicle is in the region of an intersection, the surroundings region may comprise the intersection.

The antenna array may in some embodiments comprise the first and second subarray. Further subarrays are also conceivable in some embodiments.

For example, multiple subarrays of the antenna array may be used depending on which surroundings region is to be sensed.

The surroundings region may for example be sensed at least in regions by means of the first subarray. For this purpose, the first subarray may comprise a first field of view which extends at least partially, in particular completely, within the surroundings region. Therefore, the first subarray is able to carry out sensing or else target detection in the surroundings region. The second subarray in turn may comprise a second field of view which extends at least partially, in particular completely, within the surroundings region. Therefore, the surroundings region can be sensed or else covered at least partially, in some embodiments completely, by means of the first and second subarrays.

The two fields of view in each case may comprise outer edge regions. This may again result in the problem mentioned at the outset, since the directional accuracy and, for example, resolution or rather angular resolution may be inaccurate, poor, or less precise. If, for example, objects such as potential collision objects are located in the edge regions, worse sensing may be carried out here compared with the other regions of the fields of view. In some embodiments, a central region of the field of view that is surrounded by the edge region may be used for accurate sensing. The two fields of view may intersect or else overlap at least partially or else in regions. This is because the same surroundings region is to be sensed with the two subarrays. In some embodiments, the two fields of view may be configured to be adjacent to one another. In some embodiments, the edge regions of the fields of view arranged adjacent to one another may at least partially overlap or else be superimposed one on the other. There is therefore a region, for example the overlapping region, that can only be sensed in an unsatisfactory manner by both subarrays. If an object such as a potential collision object for the vehicle is then located within this overlapping region, this object may be sensed inaccurately and, in the worst-case scenario, it may not be possible to carry out any target detection at all.

The check of the overlapping region can be done with regard to whether the first and/or second subarray can sense or else have sensed the object to be detected.

For example, in the present case, the first and/or second subarray may at least partially detect or else sense shadowing or else anomalies that indicate a potential object, for example the object to be detected. Thus, it can be for example established on the system side that the overlapping region, in which only unsatisfactory target sensing or else object detection is possible, may be problematic for the environment sensing. The combination array can in some embodiments be determined or else generated to remedy this. In other words, reconfiguration may take place on the basis of the two subarrays, and therefore the combination array is composed of individual antenna elements of the two subarrays. The overlapping region and the object to be detected are taken into account here. In other words, the combination array is determined such that the object to be detected or else multiple objects to be detected that were located in the edge regions of the fields of view of the first and second subarray are now no longer located in the edge regions in the combination field of view of the combination array, but rather in particular in a central region of the combination field of view. Therefore, the two fields of view of the two subarrays can be changed to produce an improved combination field of view in some embodiments. The subregion of the surroundings region which could only be sensed in an unsatisfactory manner by the first and second subarray can now be sensed in this improved combination field of view by means of the combination array.

In some embodiments, the proposed method allows for consecutive, i.e., temporally subsequent, interconnection of subarrays of an antenna array. Therefore, corresponding subarrays may be used depending on which region in the surroundings of the vehicle is to be sensed and if these subarrays are not sufficient for carrying out substantially precise sensing, these individual subarrays may in turn be merged such that sensing that is suitable for this sensing situation or else improved sensing can be carried out.

Another application scenario would be that the subarrays of the antenna array may individually comprise blocked viewing regions due to masking effects. As a result, in order to provide a remedy here, corresponding subarrays may in turn be combined in order to obtain an improved array in order to determine the respectively relevant surroundings region, in particular for the relevant driving situation of the vehicle.

These proposed methods may be realized using miniaturized, photonic co-integrated radar chips in a coherently distributed, thinned array or rather antenna array in some embodiments. This antenna array may in some embodiments be integrated over a large area in or on the vehicle. Moreover, conversion of the optical transmission of a radar signal on an electronic-photonic co-integrated semiconductor circuit may take place into at least two different frequencies. These may be the respective signals of the individual subarrays in some embodiments.

Individual subarrays may be calculated/determined on the basis of the fields of view of the subarrays and the received signals of the subarrays. Here, the fields of view, for example, are checked. If the edge regions of the subarrays are preventing reliable environment sensing, a redesign, in particular online new design, of the relevant subarray as a subset of the overall array or else of the first and second subarray, can take place adaptively depending on the driving scenario.

On account of the proposed method according to some embodiments, the resolution can be refined in the relevant field of view. In some embodiments, the accuracy of the target detection can be increased. Moreover, the required computing capacity may be lower in some embodiments. Equally, the CO₂ emissions can be reduced in some embodiments. Moreover, on account of the thinned and, in particular, distributed arrangement of the antenna array, electrical energy can be saved, such that, for example, the range of electrically operated vehicles can be increased in some embodiments. In some embodiments, the proposed method produces a cost saving.

Due to physical interrelationships, the angular resolution of a sensor system, in particular of a radar system, is determined by the extent of the antenna aperture thereof. “Antenna aperture” is understood herein as the surface on which the individual antennas are arranged in a distributed manner. Current sensor systems are mostly modules having a size of around 10×10 cm², which is restricted due to the integrability in vehicles. The angular resolution may accordingly be limited to approx. 2 degrees. Here, the resolution improves proportionally to the size of the aperture. If two objects are to be resolved in angle, i.e., in azimuth and elevation, an aperture that is extended in two directions may be required.

A second variable in an antenna array is the spacing of the individual antenna elements, which determines the measurable angular range. Larger antenna spacings lead to ambiguities such as side peaks in the angle measurement. Radar systems in the automotive industry thus use so-called virtual antenna elements. A virtual element of this kind results from the combination of a transmission antenna with a receiving channel and specifically exactly on the center of the connection vector. With n-transmission antennas and m-receiving antennas, a virtual array consisting of a maximum of n×m elements can be produced. This principle is commonly known as “multiple input multiple output (MIMO)”. On account of some embodiments, the clearly measurable angular range of the antenna array may be increased.

The individual antenna elements of the antenna array may be arranged so as to be distributed over 360 degrees and in 3D along the surface of the vehicle. This produces many channels, in particular communication channels, which may be coherently computed into an overall point cloud.

The required computing capacity may be increased by arranging the antenna array in a “sparse array configuration” in some embodiments.

In some embodiments, the data load may be reduced in photonic radar systems that are distributed over large areas.

The surroundings region of the surroundings of the vehicle is, for example, a region in the surroundings within which a driving maneuver of the vehicle takes place or else is carried out at least partially.

The sensor system of the vehicle may, for example, be configured as an environment sensing system. For this purpose, the sensor system may comprise the antenna array or multiple such antenna arrays.

The antenna elements of the antenna array may be configured as transmission elements, receiving elements, or transceiver elements.

For example, it can be established on the system side in which direction or spatial region in relation to a vehicle a corresponding surroundings region that is relevant for the current and/or future driving behavior of the vehicle is located. For this purpose, for example, vehicle data, map data, or navigation data can be taken into account.

In some embodiments, it is provided that, during the check of the overlapping region, it is additionally checked whether the at least one object to be detected can be sensed by means of the first subarray and/or by means of the second subarray. As a result, firstly, the overlapping region can be checked as to whether an object to be detected or other objects that pose a hazard to the vehicle are located in this intersecting region of the fields of view of the two subarrays. Secondly, the overlapping region can additionally be checked in some embodiments with regard to whether objects within this overlapping region can also actually be sensed by at least one subarray. If sensing by means of the first or second subarray is not possible in this overlapping region, it can be assumed that a relevant object, for example the object to be detected, is located in a region of the surroundings region which cannot be sensed by the first and second subarray. In this case, it is possible to draw on a further subarray, by means of which it can be checked whether or not sensing of the object is possible with this further subarray. Therefore, any desired subarrays of the antenna array can be combined or else merged in any desired manner depending on the present situation in some embodiments.

During the check of the overlapping region as to whether an object to be detected is located therein, the object may in some embodiments be sensed at least partially by means of the first subarray and/or second subarray. Thus, it is known on the system side that an object is located in the overlapping region but cannot be sensed fully. To remedy this, the combination array can again be formed in some embodiments.

This produces the benefit that, in the wide variety of situations, circumstances, and/or traffic situations, it is possible to connect or rather interconnect the antenna array such that substantially accurate and, in for example, complete environment sensing of the respectively relevant surroundings region can be carried out.

In some embodiments, it is provided that the combination array is determined if the at least one object to be detected is located within the overlapping region and the at least one object to be detected can only partially be sensed by the first subarray and by the second subarray. If collision objects, target objects such as the object to be detected is located in this critical region with regard to the overlapping region and this object can only be sensed insufficiently or else partially by the first and second subarray, it may be specified on the system side that the combination array should be determined. Therefore, it may be specified on the system side in which conditions with regard to insufficient sensing the combination array is formed on the basis of the subarrays and, for example, the individual antenna elements of the subarrays.

In some embodiments, it is provided that, if the at least one object to be detected is located within the overlapping region and the at least one object to be detected may be sensed by the first subarray and by the second subarray, the first subarray and the second subarray are adjusted and/or at least one further subarray of the antenna array is used to sense the surroundings region. If the object to be detected or other target objects located in the field of view of the first and/or second subarray can be sensed by the first and second subarray, this can be used for the environment sensing. In this case, the determination of the combination array can optionally be dispensed with. Additionally or alternatively and in some embodiments, the subarrays may be calibrated or else adjusted such that they can carry out substantially complete sensing of the object to be detected.

If the object to be detected cannot be sensed completely or else sufficiently by the first and second subarray and thus these two subarrays can only be used to a limited extent to form the combination array, it is possible to draw on a further, e.g. a third, subarray in some embodiments. Thus, it is also conceivable for three fields of view of three subarrays to be assessed. Here, the overlapping region may, for example, be an overlapping region of the edge regions of the three fields of view. The sensing probability and, for example, the target detection can be made more efficient by using a further subarray.

If the object to be detected or else the target object cannot be sensed by the first or second subarray, calibration or else fine-tuning of the first and/or second subarray may firstly take place. Here, the actuation of the individual antenna elements of the two subarrays may be adjusted. It is also conceivable for further antenna elements of the antenna array to be connected or else added to the first subarray and/or to the second subarray in order to extend the field of view of the first and/or second subarray. This may take place until, for example, the object to be detected can be at least partially sensed by the first and/or second subarray, such that the combination array can subsequently be formed in turn. In addition to the use of the further subarray, multiple further such subarrays can also be drawn on or else taken into account in some embodiments. Therefore, any desired subarrays can be taken into account accordingly and then combined into the combination array in some embodiments.

In some embodiments, it is provided that, if no object to be detected is located in the overlapping region, the surroundings region of the surroundings is sensed by means of the first and/or second subarray. As a result, computing power and computing time, for example, can be saved, since the combination array does not need to be generated or else determined when this is not appropriate. If it is established on the system side that sufficient sensing of the object to be detected is possible with the first and/or second subarray, the sensing of the surroundings region takes place with the first and/or second subarray.

“Insufficient sensing” may be understood to mean that the object can be sensed with a probability or rather detection probability of less than 40%, for example less than 30%. If, in turn, sensing of the object is possible with the first and/or second subarray with a sensing probability of greater than 50%, for example greater than 70%, sensing is considered sufficient.

For example, it can be established using other systems or external sources of information that there is no object in the overlapping region. Otherwise, it can in turn be established by means of the first and second subarray with a sensing accuracy of greater than 90%, for example greater than 95%, that no object is located in the overlapping region. In this case, it is therefore possible to dispense with the formation of the combination array, since sufficient sensing by the first and/or second subarray is possible.

In some embodiments, it is provided that an item of surroundings information relating to the surroundings of the vehicle and/or a traffic situation in the surroundings of the vehicle and/or a current and/or future driving scenario of the vehicle is taken into account during determination of the combination array. As a result, the combination array may be determined in a manner more appropriate to the situation. In addition to the object to be detected and the overlapping region with regard to the fields of view of the two subarrays, further information may also be taken into account in order to determine a combination array which is appropriate for the current and/or imminent situation of the vehicle in some embodiments. For this purpose, corresponding information relating to the surroundings and/or the traffic situation may be made available by means of vehicle systems and/or vehicle-external sources of information. Information relating to the current and future driving scenario may be provided by driver assistance systems or navigation systems of the vehicle in some embodiments.

In some embodiments, it is provided that, on the basis of a current and/or immediately imminent driving maneuver of the vehicle, a region in the surroundings of the vehicle which is relevant with regard to the current and/or immediately imminent driving maneuver is specified as the surroundings region. Information of the vehicle and/or information of a user of the vehicle, for example navigation information or route information, can be taken into account here. To reduce computing power and to operate the sensor system more efficiently, it is beneficial to sense the region which is of interest or else relevant to the current and/or immediately imminent driving maneuver of the vehicle. Based on the current or else immediately imminent driving maneuver, it is possible to establish on the system side which surroundings region of the surroundings or which surroundings regions of the surroundings is relevant to the relevant driving maneuver. This has the additional benefit that it can thus also be specified which subarrays or else regions of the antenna array are fundamentally required for sensing the relevant surroundings region. This makes it possible to make a targeted selection as to which subarrays are also actually relevant for the sensing of the surroundings region.

If the vehicle moves to an intersection, the subarrays directed toward the intersection are of interest in this situation in some embodiments. The subarrays arranged, in this example, on the rear region of the vehicle, may potentially be disregarded in this situation. If the vehicle is then in a turn-off situation as the driving maneuver, the subarrays that may sense the turn-off region are again of interest. In another example, the vehicle may be in a passing maneuver, and therefore the traffic behind and the region in front of the vehicle should be sensed in this case. Here, the corresponding arranged subarrays that meet these conditions can in turn be actuated.

Therefore, the relevant surroundings region may be specified depending on which driving maneuver of the vehicle is currently being carried out and/or will be carried out in future and/or depending on the relevant traffic situation. As a result, the regions of the antenna arrays that are in turn fundamentally capable of sensing or else sensorially covering said surroundings region can also be specified.

Moreover, this offers a benefit in terms of the arrangement of the antenna array in a sparsely populated arrangement. Since the individual antennas of the antenna array are spaced apart from one another and, for example, are arranged so as to be distributed on the vehicle, antenna elements that are fundamentally capable of sensing the desired surroundings region can be merged in a targeted manner into a subarray.

In some embodiments, it is provided that, on the basis of the current and/or immediately imminent driving maneuver and/or the surroundings region, it is specified which subarrays of the antenna array and/or what number of subarrays of the antenna array are used for sensing the surroundings region. As a result, it may be specified or else defined on the system side which antenna elements and, for example, which regions of the antenna array are fundamentally capable of sensing the corresponding surroundings region. Therefore, antenna elements, in particular subarrays of the antenna array, that are not fundamentally capable, for example on account of their arrangement on the vehicle, of sensing the desired surroundings region can remain excluded or else ignored here. As an example of this, it may be that the surroundings region extends to the left from the vehicle, and therefore in this case the antenna elements located on the right vehicle side would not be capable of carrying out corresponding sensing of this surroundings region.

In some embodiments, the antenna array is a flexibly configurable array, and therefore depending on the desired application scenario or else depending on the present situation, the subarrays and/or the combination array can be formed in any desired manner from various antenna elements.

In some embodiments, subarrays that comprise a sensing region directed toward the surroundings region can be selected or else specified.

Moreover, each of the subarrays may comprise any desired number of antenna elements. In some embodiments, adjacent antenna elements may be respectively compiled into a subarray.

In some embodiments, it is provided that the surroundings region is sensed by means of the combination array with regard to the at least one object to be detected and/or with regard to a potential collision object. With the aid of the combination array that is newly formed or else determined in a situation-dependent manner, the surroundings region can be sensed with regard to target objects or else collision objects. In some embodiments, sufficient sensing of the surroundings region can be carried out with the combination array.

In some embodiments, it is provided that further subarrays of the antenna array can be adjusted on the basis of the combination array and combination field of view, wherein the further subarrays can be adjusted on an ongoing basis proceeding from the combination array.

As a result, the information with regard to the generated combination array can be used, on this basis, to configure or else adjust further subarrays of the antenna array. The ascertained combination field of view can, for example, be transmitted or else applied to further subarrays. Therefore, the further regions of the antenna array around the vehicle can be adjusted or else configured or else adapted proceeding from the combination array as the starting point. In other words, the combination array, for example the combination field of view, can be transmitted to the subsequent subarrays of the antenna array, such that the further regions of the antenna array can be adjusted on the basis of the combination field of view in such a way that, on the basis of the design of the combination field of view, further regions in the surroundings of the vehicle can be sensed. Therefore, for example, by calculating or else determining the combination array once, this can be transmitted to the further regions of the antenna array in order to be able to carry out 360-degree environment sensing around the vehicle in the simplest manner.

For example, the realized combination of the first and second subarray can be applied analogously to further adjacent subarrays on other regions of the vehicle in order to carry out 360-degree environment sensing on the basis of the combination array determined once. For example, environment sensing can firstly be carried out here and then, depending on the circumstances, renewed determination of the relevant subarrays and of the relevant surroundings region can be carried out again.

In some embodiments, it is provided that an item of information relating to the sensed surroundings region is generated by means of a processor (also referred to as ‘computing apparatus’ herein) of the sensor system and at least provided to a vehicle system and/or environment model. Therefore, the sensed surroundings region can be provided as an item of information, for example as a signal, in order to make this available as input variables for vehicle systems, for example driver assistance systems and/or an environment model. As a result, the vehicle can be operated more safely. In some embodiments, the item of information relating to the surroundings region can beneficially be used for at least partially autonomous driving functions or fully autonomous driving functions.

Further embodiments relate to a sensor system having at least one antenna array and an electronic evaluation circuit (also referred to as ‘evaluation unit’ herein), wherein the sensor system is configured to execute a method according to one or more embodiments discussed herein or a beneficial development thereof. For example, a method as described in the preceding can be executed or else carried out by the sensor system set out just above.

For example, a transmission circuit/apparatus (i.e., a ‘transmitter’) and a receiving circuit/apparatus (i.e., a ‘receiver’) may be integrated on a single semiconductor chip, for example in a CMOS, SiM CMOS, Bi CMOS, Hybrid Bi CMOS, or with processes on photonic-electronic co-integrated chips. Therefore, for example, with the aid of the teachings herein, a radar sensor device or the sensor system can be produced by means of mass manufacturing by means of standardized semiconductor processes.

In some embodiments, by means of the sensor system, frequency conversion of a terahertz carrier signal in the gigahertz frequency range can be carried out after optical signal transmission and, conversely, reception of gigahertz signals with modulation to a terahertz carrier signal.

In some embodiments, the proposed sensor system can be used in motor vehicles. In some embodiments, the sensor system can be used in motor vehicles that are, for example, at least partially autonomously operated, for example which are operated fully autonomously. For such automated travel, reliable perception of the environment may be required, which can be achieved by the sensor system. The environment or else surroundings may be sensed by means of sensors, for example radar, lidar, and/or camera sensors. These could be examples of the field of application of the radar sensor device. Comprehensive 360-degree three-dimensional sensing of the surroundings can be carried out by means of the sensor system, such that all static and dynamic objects can be sensed.

Alternatively, the sensor system can be applied to lidar, since lidar, in particular, plays a crucial role in redundant, robust environment sensing, since this sensor type can measure distances and angles more precisely in environment sensing and can also be used for classification.

In some embodiments, the sensor system may be used in motor vehicles that are, for example, at least partially autonomously operated, but in particular also those that are operated fully autonomously. However, in order to make such automated travel possible, reliable perception of the environment is beneficial. Here, the environment or else surroundings is sensed by means of sensors, for example radar, lidar, and/or camera. Comprehensive 360-degree three-dimensional sensing of the surroundings is particularly beneficial, such that all static and dynamic objects can be sensed. The sensor system can be used for this purpose. In some embodiments, lidar plays a crucial role in redundant, robust environment sensing, since this type of sensor can measure distances more precisely in environment sensing and can also be used for classification. However, these lidar sensors are cost-intensive and complex in terms of design. In particular, 360-degree three-dimensional environment sensing may be problematic, since either many smaller individual sensors are required to ensure this, which as a rule work with many individual light sources and detector elements, or large lidar sensors are installed. Furthermore, lidar sensors are susceptible to weather influences such as rain, fog, or direct insolation.

Radar sensors or else radar sensor devices are also well-known in motor vehicle construction and reliably provide data in a fail-safe manner in all weather conditions. Even poor visibility, for example with rain, fog, snow, dust, or darkness, barely influence their perceptive reliability. However, according to the prior art, the resolution has thus far been limited, in particular series radars currently in use are only designed with an angular resolution of about 2 degrees. In order to meet the requirements for an increased level of automation in motor vehicle construction with reliable driving functions, it is provided that the radar sensor device provides three-dimensional images with a high angular resolution in the region of less than or equal to 0.1 degrees with a low sensitivity to interferences in the surroundings. This is not achieved with the conventional radar technology according to the prior art, since the resolution of such systems is too low. This is where the sensor system according to the teachings herein is beneficial.

The sensor system may be configured as a photonic radar sensor device in some embodiments, which increases the resolution by co-integrating electronic and photonic components in a single semiconductor chip. The tracking of a FMCW signal as well as the overall signal processing and signal evaluation may be carried out by a central station in some embodiments. Each transmission and receiving module may comprise an electronic-photonic co-integrated chip, a so-called EPIC chip. Silicon photonics technology is used for the co-integration. This allows for monolithic integration of photonic components, high-frequency electronics, and digital electronics together on a chip. The technical innovation of such a system lies in the signal transmission of gigahertz signals by means of the optical carrier signal in the terahertz frequency range. A central station, which can also be referred to as a central electronic computing apparatus or central processor, generates an optical carrier frequency in a terahertz range. In this way, the transmitted signal is modulated with one eighth of the radar frequency and sent over the optical fiber to the antenna chips. Frequency multiplication takes place on these chips, such that the radar radiation can be emitted by the antenna chips. The signal detection may take place in reverse. All data may be processed on the central station in some embodiments.

However, a design of this kind is complex in the implementation of gigahertz electronics at the chip level. In particular, the frequency multiplication that takes place on the chip after detection by means of a photodiode may technically be challenging such as with regard to the gigahertz signal generation with a high signal-to-noise ratio and as little jitter as possible. Therefore, the gigahertz signal may be stabilized in further embodiments. Furthermore, gigahertz electronics may be costly. Furthermore, stringent power requirements may be imposed on the optical carrier, for example the laser, since a lot of optical power is required to generate a highly precise gigahertz signal, which makes ring lines with the only phase for a radar array with many distributed radar semiconductor chips difficult to realize. In some embodiments, two photonic-electronic semiconductor chips may be required for a transmission and receiving channel, which may incur cost. The issues mentioned just above are solved at least partially by means of the sensor system according to the teachings herein.

In some embodiments, the teachings herein utilize the fact that the radiation of the laser apparatus, which may for example be configured as a CW laser, is coupled in in a photonic semiconductor by means of an optical interface. This may be the optical transmission signal or else a carrier signal of the CW laser.

In some embodiments, the generation of the FMCW signal as well as the overall signal processing and evaluation are carried out by a central station, for example the computing apparatus. Each transmission and receiving module consists of an electronic-photonic co-integrated chip (so-called “EPIC chip”). Silicon photonics technology is used for the co-integration. This allows for monolithic integration of photonic components, high-frequency electronics, and digital electronics together on a chip (“electronic-photonic co-integration”). The technical innovation of such a system may lie in the signal transmission of GHz signals by means of an optical carrier signal in the THz frequency range. A central station may generate an optical carrier frequency (THz). In this way, the signal to be transmitted may be modulated with ⅛ of the radar frequency and sent via optical fiber to the antenna chips in some embodiments. Eightfold multiplication of the frequency may take place on these chips, such that the radar radiation can be emitted by the antenna chips. The signal detection may take place in reverse. All data may be processed on the central station in some embodiments.

The principle of electronic-photonic co-integration in a chip, with silicon-on-insulator regions for the photonic components and bulk silicon regions for the electronic circuits is a technology that is unique in the world. In particular in the case of high data rates, a high signal quality can thus be realized with few parasitic interferences. The connection of the HF circuits for the radar antennas including frequency multipliers to the optical transceiver can be implemented in some embodiments without additional wire or flip chip bonding. In addition, chips can already be optically and electrically tested at the wafer level, as a result of which a high yield can be achieved in the further module setup. With this technology, extremely compact form factors can be realized and, associated with this, a high relevance for the application of optical technologies on the basis of silicon photonics in the automotive industry.

A hurdle for productive use of optical fibers may be a lack of scalability of currently available technologies. This scalability to large volumes is made possible by means of the technology for the highly integrated manufacture of electronic-photonic integrated circuits. The result is a cost reduction in the assembly technology and a more efficient cost structure. Comprehensive libraries for electronic and photonic components for high-bandwidth data transmission, which are used in the project, have been developed from data center solutions.

In some embodiments, it is provided that the antenna array can be configured such that individual antenna elements of the multiple antenna elements can be compiled into various subarrays. In some embodiments, the antenna array is configured such that the individual antenna elements of the antenna array can be grouped or else merged in any desired manner to form subarrays. This produces a freely configurable antenna array, such that, for a relevant situation of the vehicle, such antenna elements can be compiled or else merged into a subarray in order to be able to optimally sense the surroundings regions that are relevant to the situation.

Some embodiments of the disclosure relate to a vehicle having a sensor system according to the discussion herein or a beneficial development thereof.

For example, the vehicle may be a manually operated vehicle, a partially autonomously operated vehicle, or a fully autonomously operated vehicle. In other words, the vehicle may be a highly automated vehicle.

In some embodiments, the vehicle may be a motor vehicle, for example a passenger car or truck.

In some embodiments, it is provided that the antenna array comprises multiple antenna elements that are arranged to be distributed at a distance from one another on the vehicle. Therefore, sensing of the surroundings of the vehicle that is as efficient as possible can be carried out. On account of the distributed arrangement of the individual antenna elements on the vehicle, 360-degree environment sensing, in particular, can be carried out.

For example, the antenna elements of the antenna array may be designed in a “sparse array” configuration. In some embodiments, the antenna elements of the antenna array may be arranged in a sparsely or thinly populated configuration on the vehicle.

In the embodiments described herein, the described components of the embodiments each represent individual features that are to be considered independent of one another, in the combination as shown or described, and in combinations other than shown or described. In addition, the described embodiments can also be supplemented by features other than those described.

Embodiments of the methods should be considered to be embodiments of the sensor system and of the vehicle.

For application scenarios or application situations which may result with the method and which are not explicitly described here, it can be provided that, according to the method, an error message and/or a request to input user feedback is output and/or a standard setting and/or a predetermined initial state is set.

Also belonging to the disclosure are developments of the sensor system according to the teachings herein and of the vehicle according to the teachings herein that have features which have already been described in conjunction with the embodiments of the methods. For this reason, the corresponding developments of the sensor system and of the vehicle are not described again.

The disclosure also includes combinations of the features of the described embodiments.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. Are schematic and not necessary to scale.

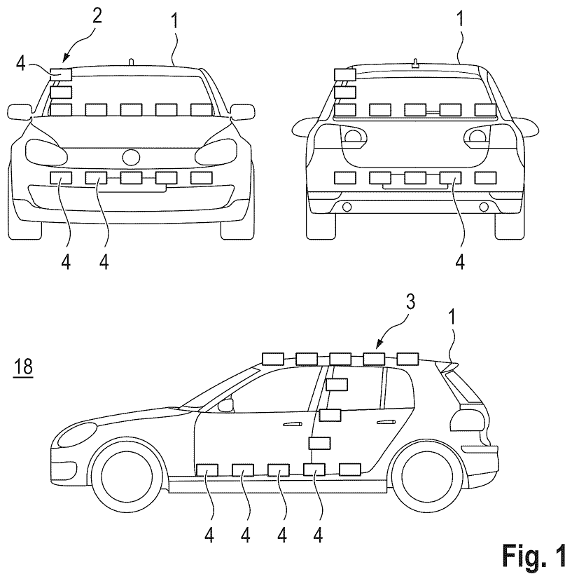

FIG. 1 shows various schematic views (front view, rear view, side view) of a vehicle 1, which may be a motor vehicle. The vehicle 1 includes, for example, a sensor system 2.

The sensor system 2 may be, for example, a radar system or an environment sensor system of the vehicle 1. For this purpose, the sensor system 2 may, for example, be communicatively linked to one or more driver assistance systems or other vehicle systems. For example, the sensor system 2 may be a radar sensor or a lidar sensor or another sensor type, in particular for vehicles. In addition to the use of the sensor system 2 in the vehicle 1, said sensor system can also be used in vehicle-external systems.

For example, the sensor system 2 comprises at least one antenna array 3 or multiple antenna arrays. The antenna array 3 may, in turn, be formed of a plurality of antenna elements 4. The antenna elements 4 may, in particular for 360-degree environment sensing, be arranged so as to be distributed at a distance from one another on the vehicle 1.

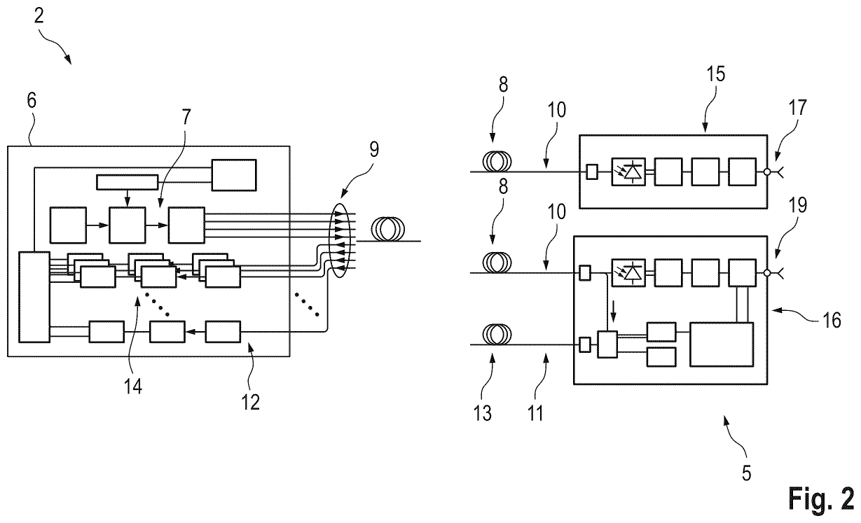

FIG. 2 shows a conceivable embodiment of the sensor system 2. The sensor system 2 may at least comprise a radar sensor device 5 and a central electronic computing apparatus 6. For example, the radar sensor device 5 and the central electronic computing apparatus 6 may be distinct and physically separated units. The radar sensor device 5 may, for example, comprise the at least one antenna array 3. Otherwise, the antenna array 3 may serve as the radar sensor device 5.

The central electronic computing apparatus 6 is a central unit. For example, the central electronic computing apparatus 6 may generate an electrical control signal by means of which a laser apparatus 7 can be actuated or else controlled. The laser apparatus 7 may, for example, be a CW laser. An optical transmission signal or else a carrier signal 8 may be generated by means of the laser apparatus 7. The optical transmission signal 8 may, in particular, be referred to as an optical carrier signal in the terahertz frequency range. The central electronic computing apparatus 6 may, for example, generate the optical carrier frequency. The signal to be transmitted is modulated to this optical carrier frequency with one eighth of a radar frequency and, for example, transmitted to the radar sensor device 5. In this way, the frequency can be multiplied by eight. In turn, signals in the gigahertz frequency range can be received and transmitted to the central electronic computing apparatus 6 by means of the radar sensor device 5.

For example, the central electronic computing apparatus 6 can be coupled in each case via at least one glass fiber 9 to an optical input 10 and optical output 11 of the radar sensor device 5. As a result, bidirectional signal transmission can take place between the central electronic computing apparatus 6 and the radar sensor device 5.

For example, the central electronic computing apparatus 6 may be referred to as an electronic evaluation unit.

The central electronic computing apparatus 6 may further comprise an optical receiving unit 12 which is configured to receive an optical output signal 13 that is provided to the radar sensor device 5 by means of the optical output 11. Therefore, the central electronic computing apparatus 6 can be coupled to the radar sensor device 5 via optical fiber or electronic interface, for example Ethernet. In particular, multiple radar sensor devices or antenna arrays can be coupled to the central electronic computing apparatus 6. For example, the central electronic computing apparatus 6 may comprise a processing unit 14 or else a computing unit, by means of which the received optical output signal can be processed. As a result, signal sensing and subsequent data processing of the received output signal 11 can be carried out.

In particular, the central electronic computing apparatus 6 may comprise or else provide all required control signals, data processing signals, modules, and interfaces.

For example, the radar sensor device 5 may comprise, in addition to the optical input 10 and the optical output 11, at least one transmission apparatus 15 or transmission antenna and at least one receiving apparatus 16 or receiving antenna. Therefore, the radar sensor device 5 comprises a receiving module and/or transmission module. In particular, the transmission apparatus 15 and the receiving apparatus 16 may be integrated on one and the same chip. It is also conceivable for these to be located on different semiconductor chips.

An electrical radar emission signal 17 that is based on the optical transmission signal 8 may be emitted into surroundings 18 of the vehicle 1 by means of the transmission apparatus 15. A corresponding radar signal 17 may therefore be emitted depending on the optical transmission signal 8. If this signal 17 is then reflected by objects, such as road users, roads, trees, or other objects, in the surroundings 18, an electrical reception signal 19 that corresponds to the electrical radar emission signal 17 and that is reflected in the surroundings 18 can be received.

For example, the transmission apparatus 15 may comprise at least one antenna or else an antenna unit or multiple antennas for the emission.

For example, the emitted radar emission signal 17 or else electrical emission signal and the received reception signal 19 may be in the terahertz frequency range or gigahertz frequency range. Therefore, by means of the sensor system 2, frequency conversion of a terahertz carrier signal, in particular a transmission signal 8, may be carried out into the gigahertz frequency range for emission. Conversely, gigahertz signals may be received with modulation to a terahertz carrier signal. For example, the transmission apparatus 15 may comprise at least one grating coupler and a photodiode for the emission. The receiving apparatus 16 may, for example, comprise two grating couplers, a photodiode, and a modulator for the reception.

By means of the sensor system 2, modulation with ⅛ of the radar frequency and transmission by optical fiber to the antenna chips or else antenna elements 4 are possible. Specifically, eightfold multiplication of the frequency takes place on these chips or elements, such that the radar radiation can be emitted by the antenna chips. The signal detection optionally takes place in reverse. All data can be processed on the central station.

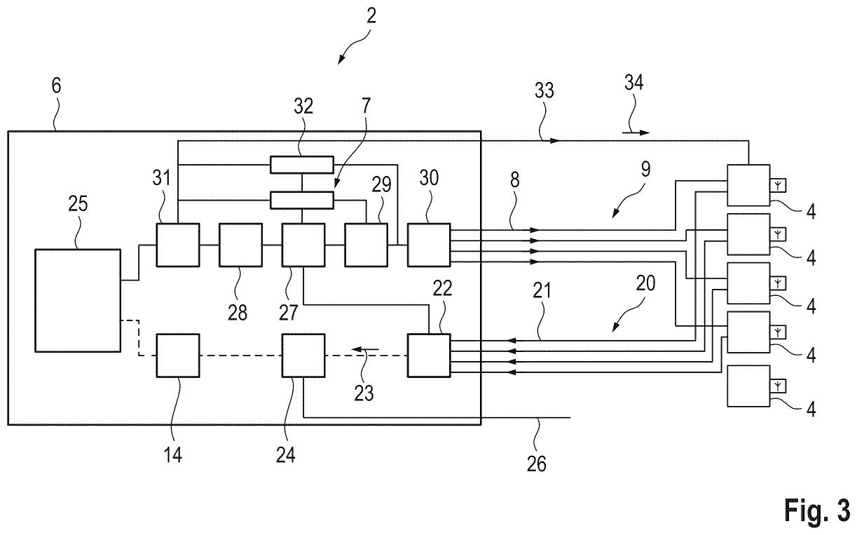

FIG. 3 shows a further conceivable embodiment of the sensor system 2. Here, the sensor system also comprises the computing apparatus 6, which in this embodiment may have a different configuration or else equipping.

The sensor system 2 specifically comprises multiple transceiver units, for example the antenna elements 4, which may, for example, be arranged so as to be distributed on the vehicle 1, in particular for environment sensing.

The transceiver units or else antenna elements 4 can be used both to transmit and to emit or else receive signals. Therefore, the transceiver units are combined units for emitting and receiving signals.

In particular, a transceiver unit of this kind may be referred to as a transceiver module. It may be referred to or else formed from an electronic-photonic co-integrated chip (so-called “EPIC chip”). The computing apparatus 6, which may be referred to as a central unit, may also be formed from an electronic-photonic co-integrated chip. In particular, the computing apparatus 6 is a unit that is physically and/or spatially separated from the transceiver units.

For example, the computing apparatus 6 may comprise an optical unit or else the laser apparatus 7 or else a laser. In particular, the optical unit may be designed as an optical source or as a CW laser. The optical transmission signal 8 or else a carrier signal can be generated and thus provided by means of the optical unit. The optical transmission signal 8 may, in particular, be designed as an optical carrier signal in the terahertz frequency range. The computing apparatus 6 may, for example, generate the optical carrier frequency. The signal to be transmitted can be modulated to this optical carrier frequency with one eighth of a radar frequency and, for example, transmitted to the transceiver units. In this way, the frequency can be multiplied. In turn, signals in the gigahertz frequency range can be received by means of the transceiver units.

For example, the computing apparatus 6 may be connected to a relevant transceiver unit via a glass fiber 9 as an optical transmission path. Signals, in particular optical signals, can be transmitted from the computing apparatus 6 via the glass fiber 9 to the individual transceiver units. In order to, in turn, be able to transmit received signals of the transceiver units back to the computing apparatus 6 for evaluation or else signal processing, a relevant transceiver unit can be optically coupled via an optical backward channel 20 to the computing apparatus 6.

The electrical emission signal 17 can be emitted by means of at least one of the transceiver units, in particular into the surroundings 18. Likewise, an electrical reception signal 19 that corresponds to the electrical emission signal 17 can, in turn, be received by the transceiver unit. For example, the emission signal 17 may be reflected by an object in the surroundings 18 of the vehicle 1 and thus received as an electrical reception signal 19. The reception signal 19, which may be referred to, for example, as a radar signal, can be forwarded or else transmitted to the computing apparatus 6 for evaluation or else signal processing. For this purpose, the electrical reception signal can be converted into an optical reception signal 21 by means of the transceiver unit. For example, said signal can be transmitted via the backward channel 9 of the computing apparatus 6. The optical reception signal 21 can, in turn, be converted into an electrical signal 23 by means of an optical-electrical converter unit 22 or else detector unit of the computing apparatus 6. The unit 22 may, for example, be used for optical detection. For this purpose, the conversion may take place, for example, by means of homodyne detection or heterodyne detection. Moreover, the unit 22 may perform a phase measurement and/or a phase length measurement.

Subsequently, digitalization may, in turn, take place by means of a digital interface 24. In the process, analog-digital conversion, in particular, may take place. For this purpose, the digital interface 24 may comprise an analog-digital converter. A processing unit 14 may be arranged downstream. By means of this processing unit, signal processing, for example, can be applied, in particular in the case of a “low-level signal”. For example, a fast Fourier transform (FFT) may be used for this purpose. Subsequently, the digitalized processed electrical signal 23 can be made available to a CPU 25 of the computing apparatus 6. Here, in particular, an item of radar information or else environmental information contained in the electrical signal 23 can be evaluated or else processed. Furthermore, an electrical backward channel 26 may be provided, which provides feedback from at least one of the transceiver units to the computing apparatus 6 and, in particular, to the digital interface 24.

In order to be able to carry out environment sensing or else detection of the sensor system 2 as stably as possible and with as little noise as possible, the optical transmission signal 8 can be adjusted by means of frequency synthesis or rather gigahertz frequency synthesis. For this purpose, the computing apparatus 6 may comprise a synthesis unit 27. The optical transmission signal 8 can be supplied or else transmitted to the synthesis unit 27 for this purpose. For example, modulation is performed before the optical transmission signal 8 is made available to the synthesis unit 27. For this purpose, a modulator or else modulation unit 28, for example, may be provided. Said modulator or else modulation unit may be designed as an arbitrary waveform generator or else arbitrary function generator (AWG). An optical control unit 29 as well as an optical switch or else distributor 30, for example, may be provided downstream of the synthesis unit 27 in the computing apparatus 6, in order to be able to make correspondingly processed signals of the synthesis unit 27 available to the transceiver units via the glass fiber 9. Moreover, a control unit 31 may be controlled by the evaluation unit 25 in order to be able to monitor or else control the generation of the optical transmission signal, in particular. Moreover, a control unit or else a feedback loop 32 may be provided.

Moreover, the computing apparatus 6 is electrically connected to the transceiver units by means of an electrical transmission path 33. An electrical control signal 34 for controlling or else actuating the transceiver units or else antenna elements 4 may be transmitted via this electrical transmission path 33.

In particular, the computing apparatus 6 serves to generate an optical carrier signal, the optical transmission signal 8, and to feed same into a gigahertz frequency synthesis unit, for example the synthesis unit 27. The synthesized gigahertz signal may be transmitted in the optical spectral range via fiber, i.e. the glass fiber 9, to the transceiver units, such that, for example, a 77 gigahertz signal can be emitted or else sent out from transceiver units. The signal detection may, in turn, take place in reverse. All data can be processed in the computing apparatus 6.

The embodiments of the computing apparatus 6 in FIG. 2 and FIG. 3 can be combined in any desired manner.

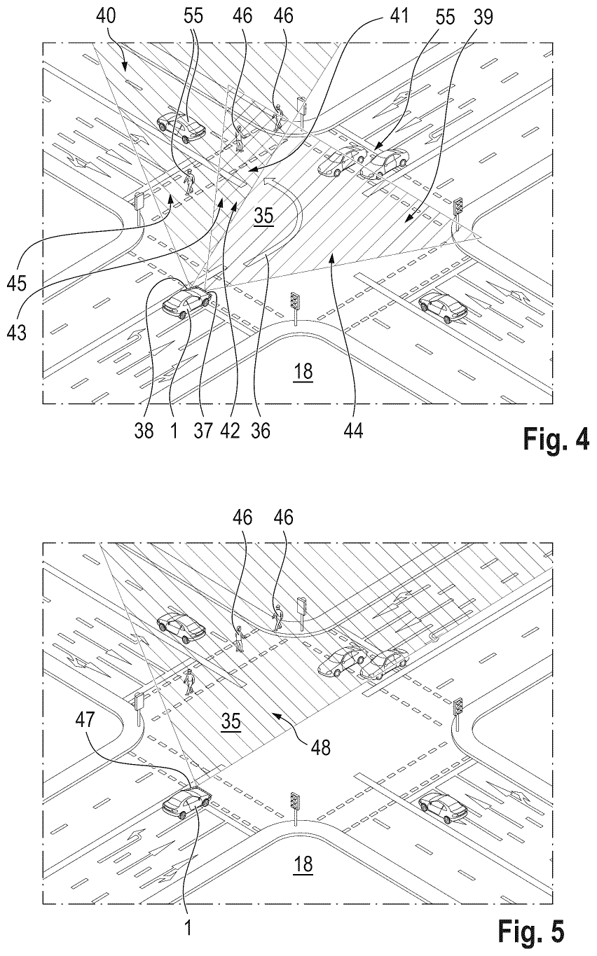

In FIG. 4 and in the following figures, exemplary embodiments relating to the sensing of the surroundings 18 of the vehicle 1 by means of the sensor system 2 are explained.

In FIG. 4, a conceivable scenario or else a conceivable situation, a turn-off procedure of the vehicle 1 at an intersection or rather road intersection, is represented. Here, the vehicle 1, which comprises the sensor system 2, is moving along a lane of a roadway, wherein the vehicle 1 is located on a left turn-off lane. The exemplary turn-off procedure here, as an exemplary driving scenario of an intersection situation, can be initiated by a driver assistance system of the vehicle 1 and/or by a user of the vehicle 1.

Here, a surroundings region 35 that is relevant to this turn-off procedure is located in front of the vehicle 1 in the region of the left turn-off procedure potentially to be carried out or else to be carried out in the future. This surroundings region 35 is of interest, in particular, for driving maneuvers 36 to be carried out, in this case the turn-off procedure at the intersection. For this purpose, it can initially be established or else specified, in particular by the sensor system 2, which regions of the antenna array 3 are to be used or else actuated in order to be able to sense the surroundings region 35.

For this purpose, a first subarray 37 and a second subarray 38 are used in this situation. The first subarray 37 may, for example, be arranged in the front region of the vehicle 1. In this case, the second subarray 38 is arranged, for example, in the region of the driver's side of the vehicle 1. Therefore, the parts or else regions of the antenna array 3 that are arranged or else oriented so as to be able to at least partially sense the surroundings region 35 are active or else in use here as the subarray 37, 38. The surroundings region 35 may be at least partially sensed by means of the first subarray 37. For this purpose, the first subarray 37 comprises a first field of view 39 which extends at least partially within the surroundings region 35. The field of view 39 may, in this case, have a triangular shape or else a cone shape. The surroundings region 35 may be at least partially sensed by means of the second subarray 38. For this purpose, the second subarray 38 comprises a second field of view 40 which extends at least partially within the surroundings region. The two subarrays 37, 38 are thus selected such that they overlap or else intersect at least partially in their fields of view 39, 40. Therefore, a region that is as wide as possible or else that covers as large an area as possible can be sensed by means of these two subarrays 37, 38.

As represented by way of example in FIG. 4, the two fields of view 39, 40 overlap at least partially. This produces an overlapping region 41 in this case. As already explained at the outset, the resolution decreases at the edges or rather at the edge regions of the subarrays 37, 38, in particular in the fields of view 39, 40 thereof. The overlapping region 41 is formed, in particular, by the edge regions 42, 43. The edge regions 42, 43 are, in particular, the regions of the fields of view 39, 40 which form the outer contour or else outer boundary of the fields of view 39, 40 with respect to the center or else middle of the fields of view 39, 40. Looking in the travel direction or else longitudinal direction of the vehicle 1, the edge region 42 of the field of view 39 is located in the outer left region of the field of view 39 and the edge region 43 of the second field of view 40 is located at the outer right edge of the second field of view 40. Therefore, the edge regions 42, 43 overlap or else cover one another and form the overlapping region 41. The field of view 39 may, in turn, comprise a further edge region 44 that is opposite the edge region 42 and, in particular, is further away from the surroundings region 35 and, in particular, the driving maneuver 36. Likewise, the field of view 40 may in turn comprise at least one further edge region 45 which is opposite the edge region 43, in particular is far away therefrom.

As represented by way of example in FIG. 4, two subarrays are used here. However, several, i.e. more than two, subarrays may also be used accordingly.

Objects 46 to be detected or else target objects or else potential collision objects may be located in this overlapping region 41. Due to the decreasing or else lower resolution in this overlapping region 41 due to the intersecting edge regions 42, 43, reliable sensing or else detection of these objects 46 cannot be carried out sufficiently enough or else accurately, and therefore critical or else dangerous situations may occur here, since the vehicle 1 can only sense the objects 46 in an unsatisfactory manner or, in the worst-case scenario, not take said objects into account. To provide a remedy to this, a combination array 47 (cf. FIG. 5) or else a newly formed subarray can be determined or else ascertained. In other words, the two fields of view 39, 40 and thus the subarrays 37, 38 are combined with one another or else configured such that “improved” sensing of the overlapping region 41 is possible. In other words, a combined unit, i.e., an extended subarray, is formed from the two subarrays 37, 38 or from several such subarrays. This combination array 47 is formed such that, in particular, the overlapping region 41 can be sensed such that the objects 46 can be sensed or else detected substantially completely.

In other words, a subarray, i.e. the combination array 47, is re-formed as a subset of the antenna elements of the subarrays 37, 38. Therefore, the combination array 47 is formed from the antenna elements which previously at least partially formed the two subarrays 37, 38. Thus, individual elements of the subarrays 37, 38 are fused or else merged in such a manner that the previously critical region with regard to the overlapping edge regions 42, 43 can now be sensed with regard to the objects 46. As represented by way of example in FIG. 5, the combination array 47 now comprises a field of view, in particular a combination field of view 48, which can now sense the objects 46 that could not be clearly sensed previously. In particular, the combination field of view 48 is formed such that the objects 46 are no longer located in the edge regions but rather in the central region or else close to the center of the combination field of view 48.

In particular, it can be established by means of the sensor system 2 or with other sources of information which regions in the surroundings 18 of the vehicle may be critical for the current situation with regard to the vehicle 1. The antenna array 3 can in turn be re-oriented by forming the combination array 47 on the basis of the critical regions, for example the overlapping region 41. This combination array 47 can be used to detect the targets, for example the objects 46. The corresponding information can, for example, be forwarded to an environment model.

In particular, a sensor system 2 may be a coherent sensor system of which the field of view can be consecutively extended. Here, individual subarrays can be coherently interconnected in order to generate a corresponding subarray, for example the combination array 47.

In addition to the objects 46 in the overlapping region 41, further objects 55 that are not located in the edge regions of the fields of view 39, 40 may be located in the surroundings region 35. Said objects 55 may, in turn, be detected by means of the first and/or second subarray 37, 38 and provided to a corresponding evaluation unit. Additionally, the combination array 47 may in turn be formed in order to be able to detect or else sense the further objects 46.

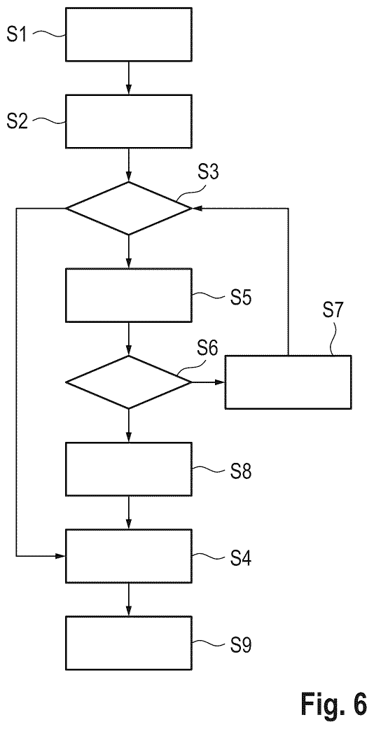

The present application is explained again in other words in an exemplary flow diagram in FIG. 6.

In a step S1, it can be checked whether the antenna array 3 of the sensor system 2 is arranged so as to be distributed at least partially, in particular completely, around the vehicle 1. For example, the sensor system 2 may be a coherent, photonic radar system. The sensors or else the antenna elements 4 may be arranged so as to be distributed in 3D and over 360 degrees around the vehicle 1. Therefore, detection of the environment or else surroundings 18 can be carried out by means of a photonic radar.

In an optional step S2, the required or else relevant subarrays 37, 38 or further subarrays can be determined based on the driving maneuver 36 to be carried out.

For example, the surroundings region 35 to be sensed can be specified on the basis of the driving maneuver 36, in particular a current or future driving maneuver. Moreover, it can be specified on the basis of the driving maneuver 36 and/or surroundings region 35 which subarrays of the antenna array 3 and/or what number of subarrays of the antenna array 3 are required for sensing the surroundings region 35. Moreover, it can be specified here which individual elements and how many individual antenna elements are to be used for the subarrays 37, 38.

In an optional step S3, the surroundings region 35 can be sensed by means of the two subarrays 37, 38. Here, it may be the case, in particular, that the two fields of view 39, 40 are superimposed one on the other in their edge regions 42, 43 and only a low resolution is available in this overlapping region 41. As a result, objects, for example the objects 46 located therein, may be detected or else sensed less accurately or else reliably. It can therefore be checked whether, in principle, potential objects are located in this overlapping region 41 and whether the potential objects 46 can be at least partially sensed by means of the subarrays 37, 38.

If no new objects are located in this overlapping region 41, in a subsequent optional step S4, target detection, environment sensing, or else sensing of the surroundings region 35 may take place on the basis of the subarrays 37, 38.

However, if objects, for example potential collision objects or road users, for example pedestrians, are located within the overlapping region 41, which cannot be sensed very well, it is possible to proceed with an optional step S5 after the step S3. In particular, target detection of the objects 46 or else potential objects may take place in the fields of view 39, 40, in particular with regard to the subarrays 37, 38. In particular, a check takes place with regard to the potential collision objects.

In an optional subsequent step S6, it can be checked whether the objects 46 could be detected. If it is established that the objects 46 are located in the overlapping region 41 but these objects 46 cannot be sensed by means of the first subarray 37 or by means of the second subarray 38, it is possible to proceed with an optional step S7.

Here, in the step S7, the individual subarrays 37, 38 can be extended, in particular in terms of their number and/or type of their individual antenna elements. Therefore, the subarrays 37, 38 can be adjusted or else adapted such that the respective fields of view of the two subarrays 37, 38 are extendable or else can be extended. Additionally or alternatively, it would also be conceivable for a further subarray arranged adjacently to the subarrays 37, 38 to additionally be used for sensing the surroundings region 35. Here, a check of the possible sensing can be carried out solely on the basis of three fields of view with regard to the three exemplary subarrays here and, in turn, a corresponding check with regard to the superimposed regions of these fields of view can be carried out.

If it is in turn established in the step S6 that at least one of these objects 46 can be partially sensed or else a corresponding shadowing or else anomaly can be sensed by means of at least one of the subarrays 37, 38, the combination array 47 can be formed or else determined in an optional step S8. Therefore, a reconfiguration of the subarrays of the antenna array 3 can be carried out here in such a way that an array is newly formed such that same has an extended or else improved field of view compared with the subarrays 37, 38, such that the relevant objects 46, in particular, can be detected. Surroundings information, traffic situations, and/or information relating to the driving maneuver 36 to be carried out can additionally be taken into account when determining or else generating the combination array. Thus, antenna elements of the subarrays 37, 38 are regrouped on the basis of the at least partially superimposed fields of view 39, 40 such that the combination field of view 48 of the combination array 47 can be provided in order to allow for improved sensing of the surroundings region 35 and, in particular, of the overlapping region 41, which was previously poorly detectable.

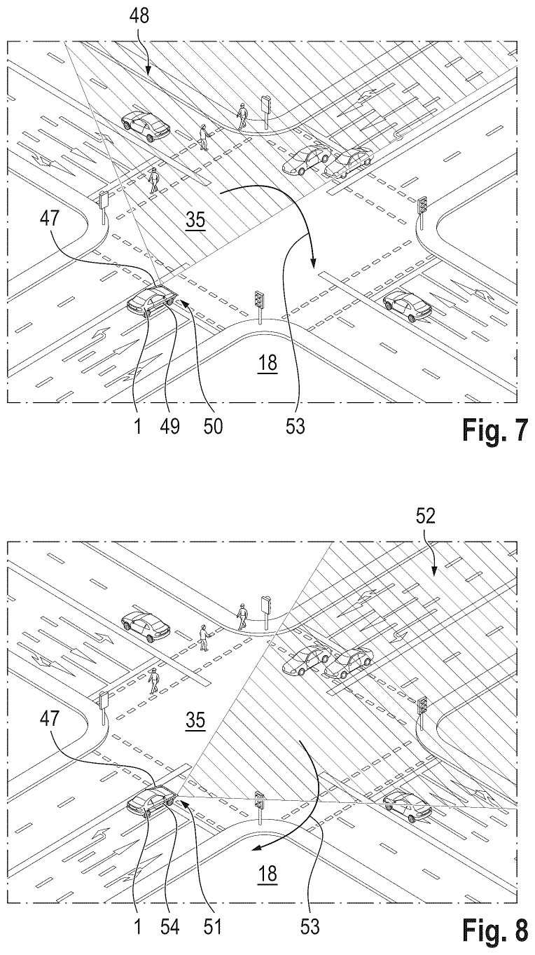

The target detection or else sensing of the surroundings region 35 can now, in turn, be carried out with the combination array 47. For this purpose, it is possible to jump back to the step S4 again. The information relating to the target objects and, in particular, objects 46 may be digitalized and provided as an electronic item of information, in particular by means of an electronic signal, vehicle systems of the vehicle 1, and/or an accident model. This may take place in an optional step S9. The subsequent figures (FIG. 7 and FIG. 8) show a further exemplary embodiment with regard to how complete environment sensing or else 360-degree sensing around the vehicle 1 can be carried out based on the generated combination array 47. In particular, this is done with minimal computation and effort.

The combination array 47 and the combination field of view 48 are represented again in FIG. 7 proceeding from FIG. 5. This merging of the two subarrays 37, 38 and, in particular, the combination field of view 48 can be applied or else adapted to further subarrays 49, 50. In other words, the further subarrays 49, 50 are also combined or else merged on the basis of the combination array 47, such that all subarrays of the antenna array 3 can in each case be merged in a corresponding manner together with adjacent subarrays successively or else on an ongoing basis, in order to be able to carry out 360-degree sensing in a simple manner, in particular with minimal computation. Explained figuratively, proceeding from the orientation or else position of the combination array 47 and, in particular, from the combination field of view 48 along the vehicle 1, in particular along the antenna array 3, said combination array can be rotated around such that further arrays can be merged analogously to the merged combination array in order to be able to duplicate this further in a simple manner for the current surroundings sensing. As a result, the environment sensing can be carried out in a simpler manner. Therefore, rotating environment sensing can be carried out by means of online adjustment of the active subarray of the overall array with the aid of the combination array 47, in particular with the combination field of view 48. As a result, the environment or else the surroundings 18 can be scanned.

In FIG. 8, proceeding from FIG. 7, the combination field of view 48 is mirrored or else continued according to the direction of rotation 53. Here, proceeding from FIG. 7, a further combination array 51 which in turn comprises a further combination field of view 52 that is in turn based on the combination field of view 48 is formed from the subarrays 49, 50 on the basis of the combination array 47. Further subarrays 54 can then in turn be adapted or else adjusted accordingly on the basis of the combination array 47 in accordance with the direction of rotation 53 until 360-degree environment sensing could accordingly be carried out.

### LIST OF REFERENCE NUMERALS

1 Vehicle
2 Sensor system
3 Antenna array
4 Antenna elements
5 Radar sensor device
6 Central electronic computing apparatus
7 Laser apparatus
8 Optical transmission signal
9 Glass fiber
10 Optical input
11 Optical output
12 Receiving unit
13 Output signal
14 Processing unit
15 Transmission apparatus
16 Receiving apparatus
17 Electrical emission signal
18 Surroundings
19 Electrical reception signal
20 Backward channel
21 Optical reception signal
22 Optical-electrical converter unit
23 Electrical signal
24 Digital interface
25 CPU
26 Electrical backward channel
27 Synthesis unit
28 Modulator
29 Optical control unit
30 Optical distributor
31 Control unit
32 Feedback loop
33 Electrical transmission path
34 Electrical control signal
35 Surroundings region
36 Driving maneuver
37 First subarray
38 Second subarray
39 First field of view
40 Second field of view
41 Overlapping region
42, 44 Edge regions of the first field of view
43, 45 Edge regions of the second field of view
46 Objects to be detected in the overlapping region
47 Combination array
48 Combination field of view
49, 50 Further subarrays
51 Further combination array
52 Further combination field of view
53 Direction of rotation
54 Further subarrays
55 Further target objects
S1 to S9 Steps

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A method for sensing surroundings of a vehicle by means of a sensor system, wherein the sensor system comprises an antenna array, wherein antenna elements of the antenna array are arranged so as to be distributed on the vehicle, the method comprising:
sensing a surroundings region of the surroundings using a first subarray of the antenna array, wherein the first subarray comprises a first field of view that extends at least partially within the surroundings region;
sensing the surroundings region of the surroundings using at least one second subarray of the antenna array, wherein the second subarray comprises a second field of view that extends at least partially within the surroundings region;
determining an overlapping region of the first and second field of view on the basis of at least partially overlapping edge regions of the first and second field of view;
checking the overlapping region with regard to whether an object to be detected is located within the overlapping region, and if the object is within the overlapping region:
selectively determining a combination array that is composed of antenna elements of the first and second subarray, on the basis of the overlapping region and the at least one object to be detected, wherein the combination array comprises a combination field of view that is composed of parts of the first and second field of view, wherein the at least one object is detectable using the combination field of view; and
sensing the surroundings region of the surroundings using the combination array.

2. The method of claim 1, wherein, during the checking of the overlapping region, checking whether the at least one object to be detected can be sensed using one or more of the first subarray and the second subarray.

3. The method of claim 2, wherein the combination array is determined so that the at least one object to be detected is located within the overlapping region and the at least one object to be detected can only partially be sensed by the first subarray and by the second subarray.

4. The method of claim 2, wherein, if the at least one object to be detected is located within the overlapping region and the at least one object to be detected can be sensed by the first subarray and by the second subarray, the first subarray and the second subarray is adjusted and/or at least one further subarray of the antenna array is used to sense the surroundings region.

5. The method of claim 1, wherein, if no object to be detected is located in the overlapping region, the surroundings region of the surroundings is sensed using the first and/or second subarray.

6. The method of claim 1, wherein an item of surroundings information relating to the surroundings of the vehicle and/or a traffic situation in the surroundings of the vehicle and/or a current and/or future driving scenario of the vehicle is taken into account during determination of the combination array.

7. The method of claim 1, wherein, on the basis of a current and/or immediately imminent driving maneuver of the vehicle, a region in the surroundings of the vehicle which is relevant with regard to the current and/or immediately imminent driving maneuver is specified as the surroundings region.

8. The method of claim 7, wherein, on the basis of the current and/or immediately imminent driving maneuver and/or the surroundings region, it is specified which subarrays of the antenna array and/or what number of subarrays of the antenna array are used for sensing the surroundings region.

9. The method of claim 1, wherein the surroundings region is sensed using the combination array with regard to the at least one object to be detected and/or with regard to potential collision objects.

10. The method of claim 1, wherein further subarrays of the antenna array can be adjusted on the basis of the combination array and combination field of view, wherein the further subarrays can be adjusted on an ongoing basis proceeding from the combination array.

11. The method of claim 1, wherein an item of information relating to the sensed surroundings region is generated using a processor of the sensor system and is at least provided to a vehicle system and/or environment model.

12. A sensor system having an antenna array that comprises multiple antenna elements and having a processor, wherein the sensor system is configured to:
sense a surroundings region of the surroundings using a first subarray of the antenna array, wherein the first subarray comprises a first field of view that extends at least partially within the surroundings region;
sense the surroundings region of the surroundings using at least one second subarray of the antenna array, wherein the second subarray comprises a second field of view that extends at least partially within the surroundings region;
determine an overlapping region of the first and second field of view on the basis of at least partially overlapping edge regions of the first and second field of view;
check the overlapping region with regard to whether an object to be detected is located within the overlapping region, and if the object is within the overlapping region:
selectively determine a combination array that is composed of antenna elements of the first and second subarray, on the basis of the overlapping region and the at least one object to be detected, wherein the combination array comprises a combination field of view that is composed of parts of the first and second field of view, wherein the at least one object is detectable using the combination field of view; and
sense the surroundings region of the surroundings using the combination array.

13. The sensor system of claim 12, wherein the antenna array is configurable such that individual antenna elements of the multiple antenna elements can be compiled into various subarrays.

14. A vehicle having the sensor system of claim 12.

15. The vehicle of claim 14, wherein the multiple antenna elements of the antenna array are arranged so as to be distributed at a distance from one another on the vehicle.

16. The sensor system of claim 12, wherein, during the checking of the overlapping region, checking whether the at least one object to be detected can be sensed using one or more of the first subarray and the second subarray.

17. The sensor system of claim 12, wherein the combination array is determined so that the at least one object to be detected is located within the overlapping region and the at least one object to be detected can only partially be sensed by the first subarray and by the second subarray.

18. The sensor system of claim 12, wherein, if the at least one object to be detected is located within the overlapping region and the at least one object to be detected can be sensed by the first subarray and by the second subarray, the first subarray and the second subarray is adjusted and/or at least one further subarray of the antenna array is used to sense the surroundings region.

19. The sensor system of claim 12, wherein, if no object to be detected is located in the overlapping region, the surroundings region of the surroundings is sensed using the first and/or second subarray.

20. The sensor system of claim 12, wherein an item of surroundings information relating to the surroundings of the vehicle and/or a traffic situation in the surroundings of the vehicle and/or a current and/or future driving scenario of the vehicle is taken into account during determination of the combination array.
